(19) United States
(12) Patent Application Publication
(10) Pub. No.: US 2026/0367608 A1
(43) Pub. Date: Nov. 19, 2026

(54) ARRANGEMENT COMPRISING A CNC MACHINING CENTER

(71) Applicant: Felder KG, Hall (AT)

(72) Inventor: Johann FELDER, Hall in Tirol (AT)

(21) Appl. No.: 19/674,925

(22) Filed: May 12, 2026

(30) Foreign Application Priority Data
May 13, 2025 (AT) GM 50046/2025

(51) Int. Cl. G05B 19/414

(52) U.S. Cl. CPC G05B 19/4145; G05B 2219/32014; G05B 2219/40131

(57) ABSTRACT

An arrangement includes a CNC machining center for machining a workpiece, and a user-wearable display device configured as an extended reality display device. The arrangement further includes an image detection device that detects image data of a real environment of the CNC machining center in real time, and a computing unit configured to create extended reality content. The computing unit configured to create extended reality content creates virtual content related to the CNC machining center and converts it into an extended reality-compatible format. The computing unit configured to create extended reality content processes the image data detected by the image detection device and converts it into an extended reality-compatible format. The extended reality display device displays both the virtual content related to the CNC machining center as well as the processed image data of the real environment of the CNC machining center.

### BACKGROUND OF THE INVENTION

The invention relates to an arrangement comprising at least one CNC machining center and at least one user-wearable display device, a method for displaying extended reality content relating to at least one CNC machining center by means of an extended reality display device, and the use of an extended reality display device, which is wearable on the body of a user, in such an arrangement for carrying out such a method.

Arrangements with at least one CNC machining center and at least one user-wearable display device are known in the prior art. Such display devices allow displaying data about a CNC machining center to a user.

A disadvantage of such arrangements known in the prior art is the static, fixedly predetermined, non-dynamic display of data. Users are also usually not given the opportunity to interact with the displayed content. The connection between the displayed data and the CNC machining center or the part of the CNC machining center to which the data refers is often not intuitively apparent.

### SUMMARY OF THE INVENTION

The object of the invention is to provide an arrangement in which these disadvantages do not occur. Preferably, a dynamic display of data should be enabled. Users should also be preferably given the opportunity to interact with the displayed content. A connection between the displayed data and the CNC machining center or the part of the CNC machining center to which the data refers should preferably be intuitively apparent.

This object is achieved by an arrangement comprising at least one CNC machining center and at least one user-wearable display device, a method for displaying extended reality content relating to at least one CNC machining center by means of an extended reality display device, and the use of an extended reality display device, which is wearable on the body of a user, in such an arrangement for carrying out such a method.

The arrangement is intended to include at least one CNC machining center for machining, in particular by chip removal, at least one workpiece, in particular a plate-shaped workpiece, in particular made of wood or of at least one wood substitute material.

A CNC machining center can be understood as a computer-controlled machine tool with which a guided movement of a machining tool can be carried out at least partially automatically.

A guided movement of a corresponding machining tool can include machining processes such as milling, drilling or sawing. Such a CNC machining center can, for example, be designed as a portal milling machine. The CNC machining center can be controlled via a computer-aided control device.

The CNC machining center can have a workpiece support for placing and holding the workpiece to be machined. The at least one workpiece can be positioned on the at least one workpiece support and held in place by it.

Alternatively or additionally, at least one clamping means can be positioned on the at least one workpiece support, which can also serve to hold the at least one workpiece. The clamping means can be positioned at least partially manually by a user. The at least one clamping means can be positioned directly on the workpiece support and/or arranged on movable supports, such as beams or brackets that can be moved along the workpiece support.

The arrangement also has at least one user-wearable display device. It is provided that the at least one user-wearable display device is designed as an extended reality display device.

The at least one extended reality display device can advantageously be designed as a virtual reality display device, and/or an augmented reality display device, and/or as a mixed reality display device.

With the extended reality display device, a user can move essentially freely around one or more CNC machining centers.

An extended reality display device can basically be understood as a device with which a computer-aided extension of the perception of reality can be achieved. An extended reality display device can present a user with an environment based on a real image, enriched with digital information/data.

For example, a user can perceive with their own eyes a real image, a camera image of a real environment, or a virtual representation of an environment, and the extended reality display device can overlay additional virtual information/data into their field of vision.

The arrangement further comprises at least one image detection device that detects image data of a real environment of the at least one CNC machining center in real time, and at least one computing unit configured to create extended reality content.

The at least one computing unit configured to create extended reality content can be connected to a storage unit via a data connection or be capable of being connected to one.

At least one image detection device can be designed as a camera that detects image data of a real environment of the at least one CNC machining center in real time. The image data can correspond to the field of vision of the user wearing the at least one extended reality display device.

The image detection device, or at least another image detection device, can detect image data of a real environment of the at least one CNC machining center in real time, wherein image data may correspond to a region outside the field of view of the user who is wearing the at least one extended reality display device. Such a region could, for example, include a region that is not directly visible to a user.

Advantageously, the arrangement comprises a control device for controlling machine functions of the at least one CNC machining center with control commands, wherein this control device can have at least one computing unit and at least one storage unit or can be in data communication with a computing unit and at least one storage unit. The computing unit can be connected to the storage unit in a data connection or be capable of being connected thereto, wherein the control device can have a communication device for wireless and/or wired communication with the CNC machining center, and/or the computing unit configured to create extended reality content, and/or the extended reality display device.

The at least one extended reality display device can have a computing unit and a storage unit which is in data communication therewith or can be brought into such a connection.

The at least one computing unit configured to create extended reality content can be implemented as a separate computer, as a computing unit of the CNC machining center, or as a computing unit of the extended reality display device.

The at least one extended reality display device may have a communication device for wireless and/or wired communication with the CNC machining center and/or the computer. The at least one CNC machining center may have a communication device for wireless and/or wired communication with the extended reality display device and/or the computer.

The at least one computing unit configured to create extended reality content creates virtual content related to the at least one CNC machining center and converts it into an extended reality-compatible format.

The at least one computing unit configured to create extended reality content processes the image data detected by the at least one image detection device and converts it into an extended reality-compatible format.

The extended reality display device is designed to display both the virtual content relating to the at least one CNC machining center and the processed image data of the real environment of the at least one CNC machining center.

Virtual content relating to at least one CNC machining center can basically be understood as all content that is provided in addition to image data detected by an image detection device.

To determine the position of the extended reality display device in space, the arrangement, in particular the extended reality display device, can have a sensor unit with at least one inertial measuring element for detecting acceleration and/or rotation data of the extended reality display device.

Alternatively or in combination, the arrangement, in particular the extended reality display device, may have an optical detection unit for detecting a position of predeterminable or predetermined position markers and/or environmental features of a real environment of the at least one CNC machining center. Predeterminable or predetermined position markers can, for example, be arranged at known positions of the CNC machining center. The optical detection unit can preferably be formed by the at least one image detection device.

Acceleration and/or rotation data, as well as positions of predeterminable or predetermined position markers and/or environmental features detected, can be processed by a computing unit to determine therefrom a three-dimensional position and orientation of the extended reality display device in space and, in particular, relative to at least one CNC machining center.

The virtual content relating to at least one CNC machining center, as well as the processed image data of the real environment of the at least one CNC machining center, can be displayed depending on the specific position and orientation of the extended reality display device in space.

In an advantageous embodiment, the at least one image detection device can detect image data relating to movements performed by a user. For example, gestures made by a user with their hands can be detected. Such gestures can be performed relative to assemblies of the at least one CNC machining center and/or relative to displayed extended reality content.

The at least one computing unit configured to create extended reality content can be configured to recognize user movements as operating commands for creating extended reality content. This allows a user to influence the extended reality content to be created and displayed. For example, it can be used to select a display of extended reality content for a specific CNC machining center or for specific operating parameters of a CNC machining center.

Alternatively or in combination, the at least one computing unit configured to create extended reality content can be configured to recognize in the image data user movements as control commands for controlling machine functions of the at least one CNC machining center.

In an advantageous embodiment, the virtual content relating to the CNC machining center may comprise at least one virtual user interface with at least one virtual control element for controlling machine functions of the at least one CNC machining center. Such a virtual user interface can, for example, provide a user with a menu-driven list of controllable machine functions, wherein interaction with the user interface can take place via at least one virtual control element. Interaction with such a virtual control element can take place, for example, via a physical input device and/or via gesture control as described above.

Alternatively or in combination, in an advantageous embodiment the virtual content relating to the CNC machining center can comprise a virtual representation of operating parameters of the at least one CNC machining center. The operating parameters can relate, for example, to machine functions and/or the machining progress of the workpiece.

Alternatively or in combination, in an advantageous embodiment the virtual content relating to the CNC machining center can comprise a virtual representation of assistance features for operating the at least one CNC machining center.

Such a virtual representation can comprise assistance features for the repair and/or maintenance of assemblies of the at least one CNC machining center, such as digital instructions or schematic diagrams. In particular, a virtual representation can be displayed to a user for manipulating a component of an assembly of the at least one CNC machining center. It is also conceivable that a user will be offered remote support for repair and/or maintenance.

In an advantageous embodiment, image data of optoelectronically readable codes, in particular QR codes, can be detected by the at least one image detection device. The at least one computing unit configured to create extended reality content can be configured to decode the encoded data contained in the image data. Virtual content related to the decoded data can be created and converted into an extended reality-compatible format for display by the extended reality display device. Creating virtual content related to the decoded data can, for example, include data read from a storage and/or data provided via a network.

In an advantageous embodiment, image data of an arrangement and configuration of functionally interconnected assemblies of the at least one CNC machining center can be detected using the at least one image detection device. Functionally interconnected assemblies can comprise machining tools, and/or clamping means, and/or workpiece supports of the at least one CNC machining center.

The at least one computing unit configured to create extended reality content can be configured to detect deviations from a target arrangement and/or a target configuration of the functionally interconnected assemblies, wherein the at least one computing unit configured to create extended reality content can create virtual content related to the target arrangement and/or the target configuration of the functionally interconnected assemblies and convert it into an extended reality-compatible format for display by the extended reality display device. A display can be created together with the processed image data of the real environment of the at least one CNC machining center.

Such extended reality content can comprise assistance features for positioning clamping means of at least one CNC machining center at the target positions. Information regarding the target position of the workpiece may also be provided. Image data of at least one clamping means, and/or at least one workpiece support, and/or the workpiece, can be displayed together with virtual extended reality content containing information on the degree of overlap between a respective actual position and the respective target position.

In an advantageous embodiment, image data of a storage device for machining tools, often referred to as a tool magazine, of the at least one CNC machining center can be detected using the at least one image detection device. The at least one computing unit configured for creating extended reality content can be configured to detect deviations from a predetermined or predeterminable target loading of the storage device with machining tools, wherein the at least one computing unit configured for creating extended reality content can create virtual content related to the target loading of the storage device with machining tools and convert this content into an extended reality-compatible format for display by the extended reality display device. A display can be created together with the processed image data of the real environment of the at least one CNC machining center. This can provide a user with an assistance feature for loading a tool magazine for a planned machining process of a workpiece.

In an advantageous embodiment, data relating to the machining processes to be executed by the at least one CNC machining center can be supplied to the at least one computing unit configured for creating extended reality content. The at least one computing unit configured to create extended reality content can create virtual content related to the machining processes to be performed and convert it into an extended reality-compatible format for display by the extended reality display device. A display can be created together with the processed image data of the real environment of the at least one CNC machining center. Such extended reality content can comprise information about at least one target machining contour on the at least one workpiece. This can be achieved, for example, by a virtual representation of the path of a machining tool of the CNC machining center. This allows machining processes to be simulated virtually and prevents a collision between a machining tool and a part of the CNC machining center, such as a clamping means, or the workpiece.

The at least one computing unit configured to create extended reality content can be configured to detect collisions between functionally interconnected assemblies of the at least one CNC machining center based on data relating to the machining processes to be performed. In particular, at least one computing unit configured for creating extended reality content can be designed to detect collisions between machining tools and a part of the CNC machining center, such as a clamping means, or the workpiece. The at least one computing unit configured to create extended reality content can be configured to create virtual content related to recognized collisions and to convert it into an extended reality-compatible format for display by the extended reality display device.

Protection is also sought for a method of displaying extended reality content related to at least one CNC machining center using an extended reality display device.

In this process, at least one image detection device initially records image data of a real environment of the at least one CNC machining center in real time.

A computing unit configured to create extended reality content processes the image data detected by the at least one image detection device and converts it into an extended reality-compatible format.

At least one computing unit configured to create extended reality content creates virtual content related to the at least one CNC machining center and converts it into an extended reality-compatible format.

The at least one extended reality display device displays both the virtual content related to the at least one CNC machining center and the processed image data of the real environment of the at least one CNC machining center.

In an advantageous embodiment of the method, the extended reality display device displays the virtual content related to at least one CNC machining center in the form of
at least one virtual user interface with at least one virtual operating element for controlling machine functions of the at least one CNC machining center, and/or
a virtual representation of operating parameters of the at least one CNC machining center, and/or
a virtual representation of assistance features for operating the at least one CNC machining center.

In an advantageous embodiment of the method, the at least one image detection device detects image data relating to movements performed by a user, for example relative to a CNC machining center and/or relative to a displayed virtual content.

The at least one computing unit configured to create extended reality content recognizes movements performed by the user as operating commands for creating extended reality content. The at least one computing unit configured to create extended reality content can create virtual content related to the at least one CNC machining center based on the operating commands and convert it into an extended reality-compatible format,A corresponding display can be created together with the processed image data of the real environment of the at least one CNC machining center.

Alternatively or in combination, the at least one computing unit configured to create extended reality content can recognize detected user movements as control commands for controlling machine functions of the at least one CNC machining center in the image data. A control device for controlling machine functions of the at least one CNC machining center can execute the detected control commands.

In an advantageous embodiment of the method, the at least one image detection device detects image data of optoelectronically readable codes, in particular QR codes, wherein the at least one computing unit configured to create extended reality content decodes the encoded data contained in the image data. The at least one computing unit configured to create extended reality content creates virtual content related to the decoded data and converts it into an extended reality-compatible format for display by the extended reality display device.

In an advantageous embodiment of the method, the at least one image detection device detects image data of an arrangement and configuration of functionally interconnected assemblies of the at least one CNC machining center, for example machining tools, and/or clamping means, and/or workpiece supports of the at least one CNC machining center.

The at least one computing unit configured to create extended reality content can detect deviations from a target arrangement and/or a target configuration of the functionally interconnected assemblies, wherein the at least one computing unit configured to create extended reality content can create virtual content related to the target arrangement and/or the target configuration of the functionally interconnected assemblies and convert it into an extended reality-compatible format for display by the extended reality display device.A display can be created together with the processed image data of the real environment of the at least one CNC machining center.

In an advantageous embodiment of the method, the at least one image detection device detects image data of a storage device for machining tools of the at least one CNC machining center, wherein the at least one computing unit configured to create extended reality content can detect deviations from a target loading of the storage device with machining tools.

The at least one computing unit configured to create extended reality content can create virtual content related to the target loading of the storage device with machining tools and convert it into an extended reality-compatible format for display by the extended reality display device. A display can be created together with the processed image data of the real environment of the at least one CNC machining center.

In an advantageous embodiment of the method, data relating to the machining processes to be performed by the at least one CNC machining center can be supplied to the at least one computing unit configured to create extended reality content, for example data read from a memory and/or data provided via a network.

The at least one computing unit configured to create extended reality content can create virtual content related to the machining processes to be performed and convert it into an extended reality-compatible format for display by the extended reality display device. A display can be created together with the processed image data of the real environment of the at least one CNC machining center.

Protection is also sought for the use of a wearable extended reality display device on a user's body in an arrangement as described above for carrying out a procedure as described above.

### BRIEF DESCRIPTION OF THE DRAWINGS

Exemplary embodiments of the invention will be discussed below with reference to the drawings, in which:

FIG. 1 shows an arrangement with a CNC machining center and an extended reality display device showing the displayed extended reality content;

FIG. 2 shows an arrangement with a CNC machining center and an extended reality display device showing an interaction with the displayed extended reality content;

FIGS. 3-6 each show an arrangement with a CNC machining center and an extended reality display device showing different extended reality content;

FIG. 7 schematically shows an arrangement with a CNC machining center and an extended reality display device; and

FIG. 8 schematically shows a method for displaying extended reality content related to at least one CNC machining center.

### DETAILED DESCRIPTION OF THE INVENTION

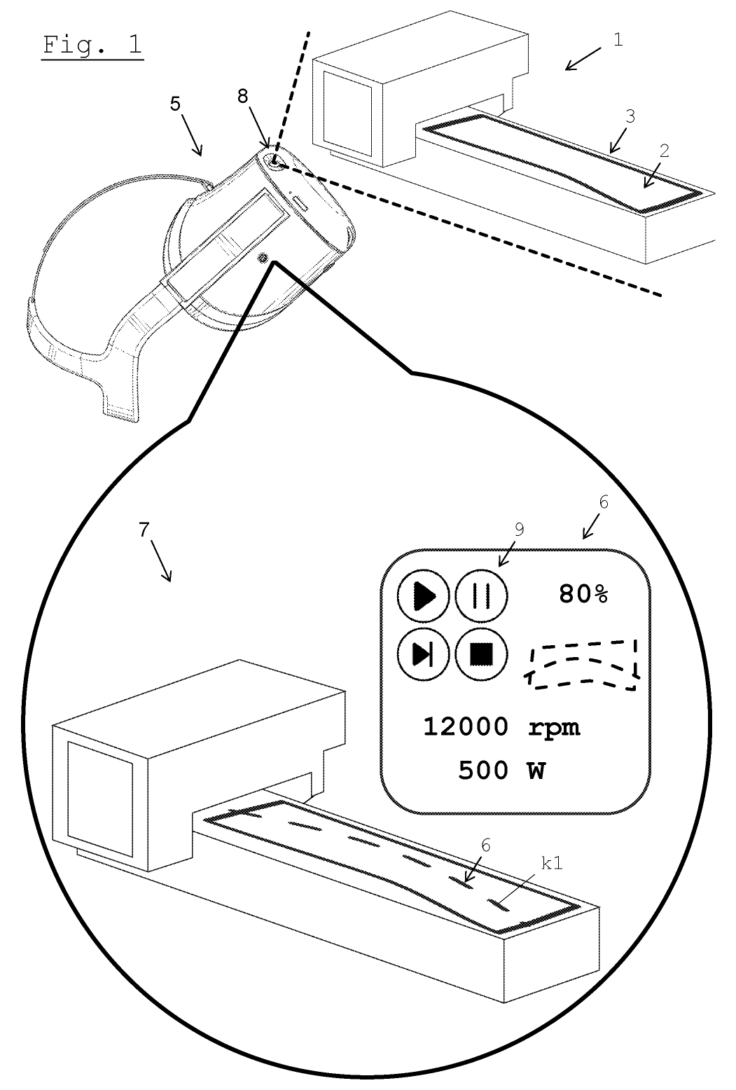

FIG. 1 shows an arrangement comprising at least one CNC machining center 1 for machining at least one workpiece 2 positioned on a workpiece support 3 and at least one user-wearable display device in the form of an extended reality display device 5. The extended reality display device 5 has an image detection device 8 that detects image data 7 of a real environment of the at least one CNC machining center 1 in real time. The extended reality display device 5 shows a user both virtual content 6 relating to the at least one CNC machining center 1 and the processed image data 7 of the real environment of the at least one CNC machining center 1.

In the representation shown in FIG. 1, the virtual content 6 relating to the at least one CNC machining center 1 comprises a virtual representation of operating parameters of the at least one CNC machining center 1, such as a rotational speed and power consumption of a machining tool, as well as a progress of a machining process.

The virtual content 6 relating to the at least one CNC machining center 1 additionally comprises, in the representation shown in FIG. 1, at least one virtual user interface 9 with at least one virtual control element 25 for controlling machine functions of the at least one CNC machining center 1.

In the representation shown in FIG. 1, the virtual content 6 relating to the at least one CNC machining center 1 also comprises virtual content 6 relating to the machining processes to be carried out, here in the form of a target machining contour k1 of a machining process. Such virtual content 6 can be created from data relating to the machining processes to be performed by the at least one CNC machining center 1 and 4 can be displayed together with the processed image data 7 of the real environment of the at least one CNC machining center 1.

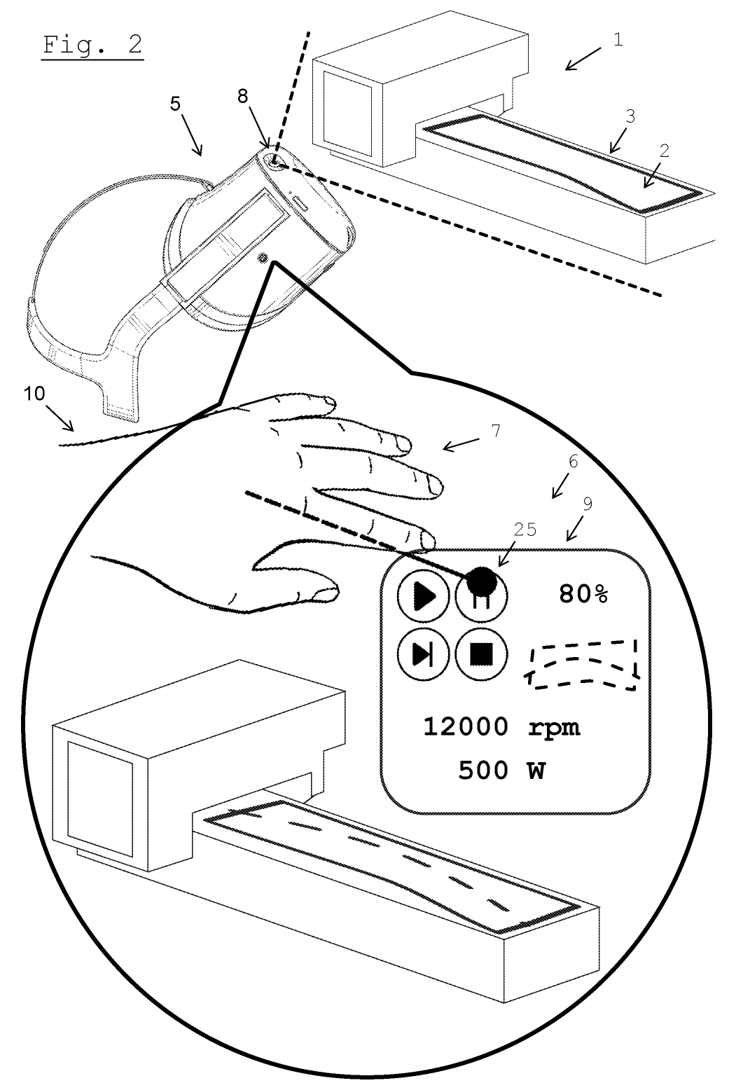

FIG. 2 shows a representation of a user interaction with displayed extended reality content, wherein at least one image detection device 8 can detect image data of movements performed by a user 10. User movements can be recognized as control commands for controlling machine functions of the at least one CNC machining center 1 in the image data 7, such as here, for example, as interaction with at least one virtual control element 25 for controlling machine functions of the at least one CNC machining center 1. User movements can also be recognized as operating commands for creating extended reality content.

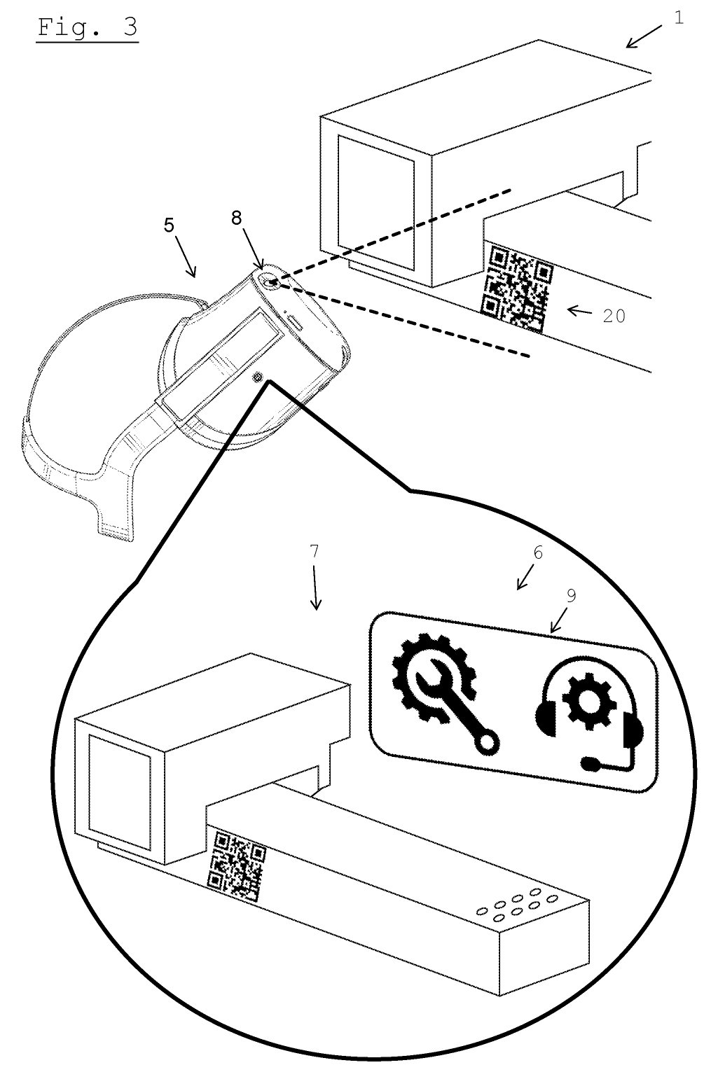

FIG. 3 shows an arrangement with a CNC machining center 1 and an extended reality display device 5 showing assistance features for operating the at least one CNC machining center 1. In the embodiment shown, image data 7 of an optoelectronically readable code 20, in particular a QR code, can be detected with the at least one image detection device 8. By decoding the encoded data contained in the image data 7, virtual content 6 related to the decoded data can be created, for example in the form of a user interface 9 with selectable digital instructions and selectable remote support for the repair and/or maintenance of the CNC machining center 1.

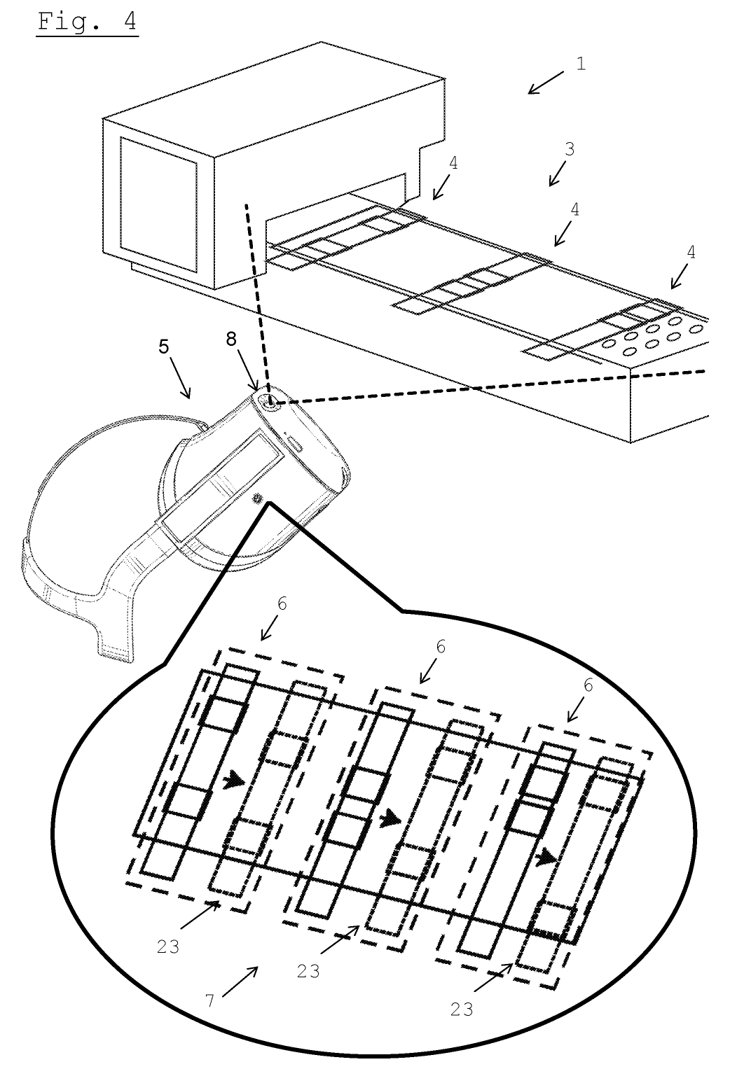

FIG. 4 shows how virtual content 6 can be used to support the arrangement and configuration of functionally interconnected assemblies of the at least one CNC machining center 1. Functionally interconnected assemblies can comprise machining tools, and/or clamping means 4, and/or workpiece supports 3 of the at least one CNC machining center 1.

With the at least one image detection device 8, image data 7 of an arrangement and configuration of functionally interconnected assemblies of the at least one CNC machining center 1 can be detected. In the representation of FIG. 4, for example, positions of clamping means 4 that are slidably mounted along a workpiece support 3 can be detected. It is possible to detect deviations from a target arrangement and/or a target configuration of the functionally interconnected assemblies and to create virtual content 6 related to the target arrangement and/or the target configuration of the functionally interconnected assemblies. In the representation of FIG. 4, such virtual content 6 in the form of contours 23 of the target position of the clamping means 4 can be displayed together with the processed image data 7 of the real environment of the at least one CNC machining center 1.

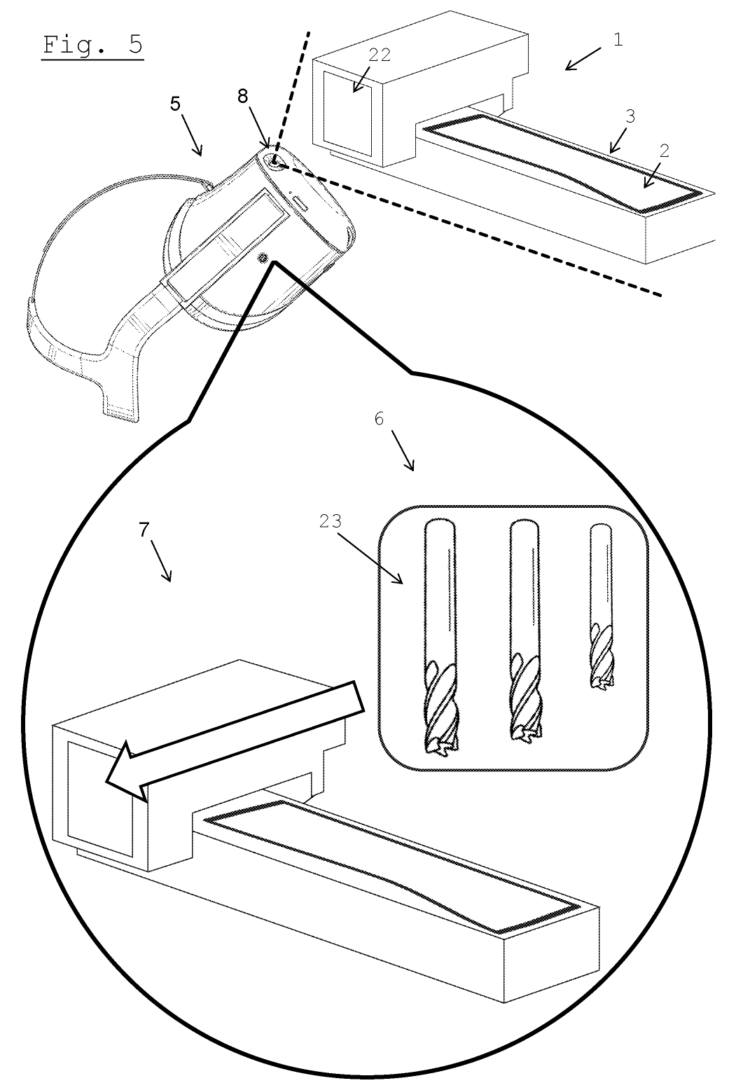

FIG. 5 shows how virtual content 6 can be used to support the loading of a storage device 22 for machining tools 23 of the at least one CNC machining center 1. In this process, the at least one image detection device 8 can detect image data 7 of a storage device 22 for machining tools 23 of the at least one CNC machining center 1. From detected deviations from a predetermined or predeterminable target loading of the storage device 22 with machining tools 23, virtual content 6 relating to the target loading of the storage device 22 with machining tools 22, here in the form of graphic representations of the required machining tools 22, can be created and displayed.

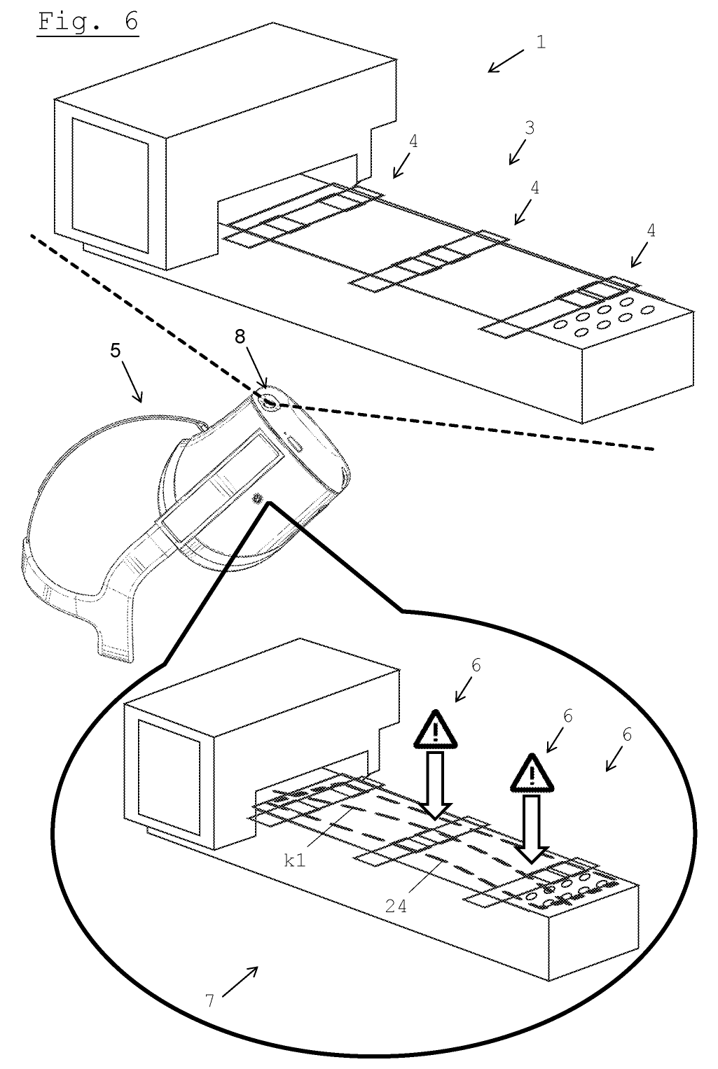

FIG. 6, analogous to FIG. 1, shows a representation of virtual content 6 related to the machining processes to be performed, in the form of a target machining contour k1 of a machining process and a contour 24 of a target position of the workpiece 2. By virtually representing a path of a machining tool 23 of the CNC machining center 1 in the form of the target machining contourk1, machining processes can be virtually simulated and a collision of a machining tool 23 with a part of the CNC machining center 1, such as a clamping means 4, can be excluded. Through collision detection, virtual content 6 related to potential collisions can be created and displayed together with the processed image data 7 of the real environment of the at least one CNC machining center 1.

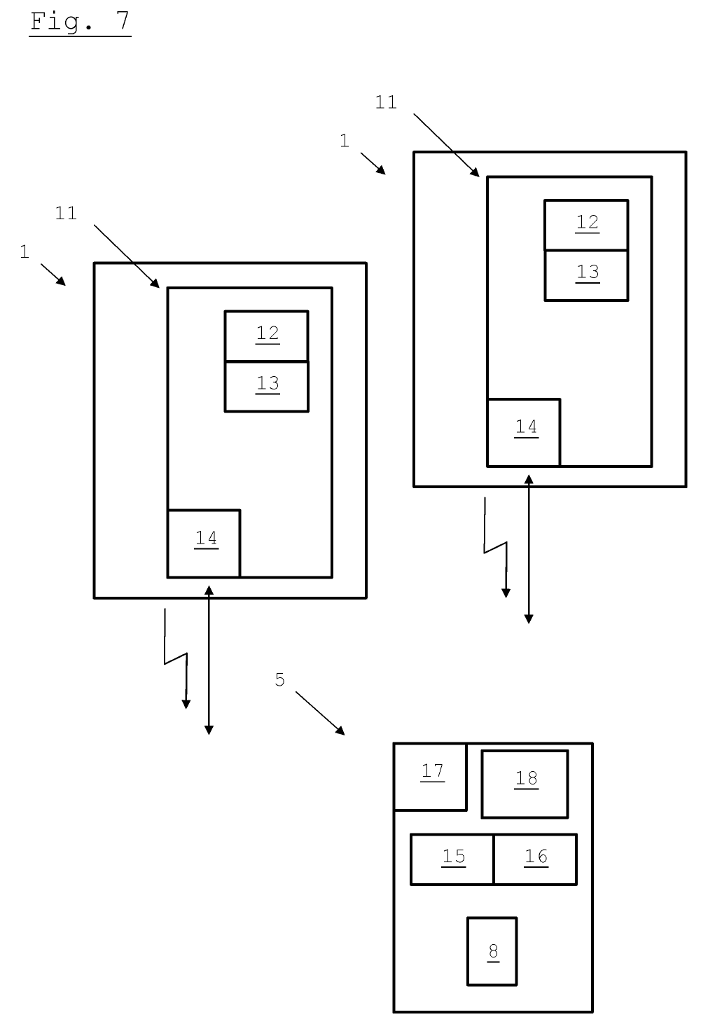

FIG. 7 schematically shows an exemplary arrangement with two CNC machining centers 1 and one extended reality display device 5. Arrangements with multiple CNC machining centers 1 and multiple extended reality display devices 5 are also conceivable.

Advantageously, at least one CNC machining center 1 has a control device 11 for controlling machine functions of the at least one CNC machining center 1 with control commands, wherein this control device 11 can have at least one computing unit 12 and at least one storage unit 13. The computing unit 12 can be in a data connection with the storage unit 13 or can be brought into such a connection. The control device 11 may include a communication device 14 for wireless and/or wired communication with the CNC machining center 1, and/or the computing unit 15 configured to create extended reality content, and/or the extended reality display device 5.

The at least one extended reality display device 5 can have a computing unit 15 and a storage unit 16 which is in data communication therewith or can be brought into such a connection.

The at least one computing unit 15 configured to create extended reality content can be implemented as a separate computer, as a computing unit of the CNC machining center 1, or as a computing unit 15 of the extended reality display device 5, as illustratively shown.

The at least one extended reality display device 5 may have a communication device 17 for wireless and/or wired communication with the CNC machining center 1 and/or a computer.

The at least one computing unit 15 configured to create extended reality content creates virtual content 6 related to the at least one CNC machining center 1 and converts it into an extended reality-compatible format.

The at least one computing unit 15 configured to create extended reality content processes the image data 7 detected by the at least one image detection device 8 and converts it into an extended reality-compatible format.

The at least one image detection device 8 can be implemented as a camera, which detects image data 7 of a real environment of the at least one CNC machining center 1 in real time.

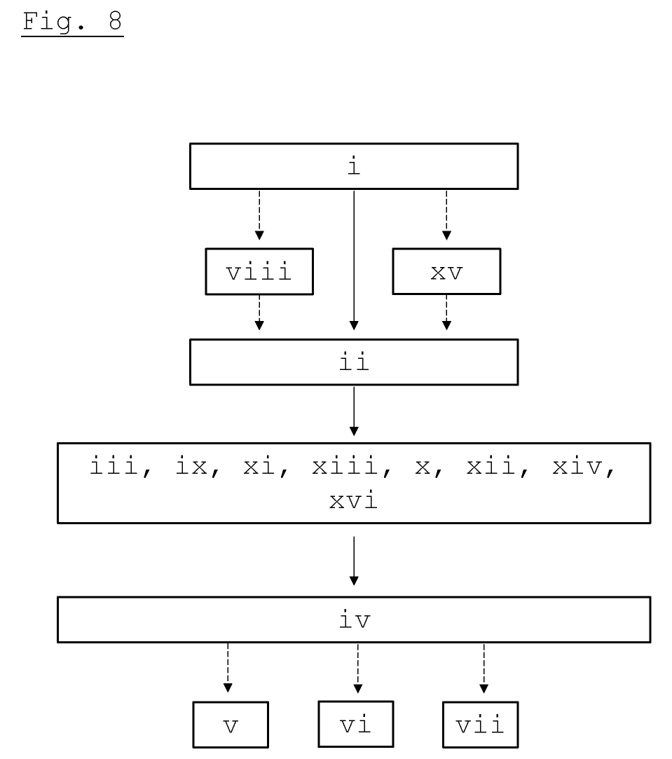

FIG. 8 schematically shows the sequence of different embodiments of a method for displaying extended reality content relating to at least one CNC machining center 1 by means of an extended reality display device 5. Different implementations of the method can be carried out at least partially sequentially and/or in parallel.

The at least one image detection device 8 can detect image data of a real environment of the at least one CNC machining center 1 in real time (i). At least one computing unit 15 configured to create extended reality content can process the image data 7 detected by the at least one image detection device 8 and convert it into an extended reality-compatible format (ii). At least one computing unit 15 configured to create extended reality content can create virtual content 6 related to the at least one CNC machining center 1 and convert it into an extended reality-compatible format (iii). The extended reality display device 5 can display both the virtual content 6 related to the at least one CNC machining center 1 and the processed image data 7 of the real environment of the at least one CNC machining center 1 (iv).

Virtual content 6 relating to at least one CNC machining center 1 can basically be understood as all content that is provided in addition to image data 7 detected by an image detection device 8.

In an embodiment of the method the extended reality display device 5 can display virtual content 6 related to the at least one CNC machining center 1 in the form

of at least one virtual user interface 9 with at least one virtual operating element 25 for controlling machine functions of the at least one CNC machining center 1 (v), and/or

of a virtual representation of operating parameters of the at least one CNC machining center 1 (vi), and/or

of a virtual representation of assistance features for operating the at least one CNC machining center 1 (vii).

In one embodiment of the method, the at least one image detection device 8 can detect image data 7 relating to movements performed by a user 10 (i) and the at least one computing unit 15 configured to create extended reality content can recognize detected user movements as operating commands for creating extended reality content and/or as control commands for controlling machine functions of the at least one CNC machining center 1 in the image data (viii). A display can be created together with the processed image data 7 of the real environment of the at least one CNC machining center 1 (iv).

In one embodiment of the method, the at least one image detection device 8 can detect image data 7 of optoelectronically readable codes 20, in particular QR codes (i), the at least one computing unit 15 configured to create extended reality content can decode the encoded data contained in the image data 7 (ix), and the at least one computing unit 15 configured to create extended reality content can create virtual content 6 related to the decoded data and convert it into an extended reality-compatible format for display by the extended reality display device 5 (x). A display can be created together with the processed image data 7 of the real environment of the at least one CNC machining center 1 (iv).

In one embodiment of the method, the at least one image detection device 8 can detect image data 7 of an arrangement and configuration of functionally interconnected assemblies of the at least one CNC machining center 1 (i), the at least one computing unit 15 configured to create extended reality content can detect deviations from a target arrangement and/or a target configuration of the functionally interconnected assemblies (xi), and the at least one computing unit 15 configured to create extended reality content can create virtual content 6 related to the target arrangement and/or the target configuration of the functionally interconnected assemblies and convert it into an extended reality-compatible format for display by the extended reality display device 5 (xii). A display can be created together with the processed image data 7 of the real environment of the at least one CNC machining center 1 (iv).

In one embodiment of the method, the at least one image detection device 8 can detect image data 7 of a storage device 22 for machining tools 23 of the at least one CNC machining center 1 (i), the at least one computing unit 15 configured to create extended reality content can detect deviations from a target loading of the storage device with machining tools (xiii), and the at least one computing unit 15 configured to create extended reality content can create virtual content 6 related to the target loading of the storage device 22 with machining tools 23 and convert it into an extended reality-compatible format for display by the extended reality display device 5 (xiv). A display can be created together with the processed image data 7 of the real environment of the at least one CNC machining center 1 (iv).

In one embodiment of the method, data relating to the machining processes to be performed by the at least one CNC machining center 1 can be supplied to the at least one computing unit 15 configured to create extended reality content (xv) and the at least one computing unit 15 configured to create extended reality content can create virtual content 6 related to the machining processes to be performed and convert it into an extended reality-compatible format for display by the extended reality display device 5 (xvi). A display can be created together with the processed image data 7 of the real environment of the at least one CNC machining center 1 (iv).

List of reference numerals:
1 CNC machining center
2 workpiece
3 workpiece support
4 clamping means
5 extended reality display device
6 virtual content
7 image data of real environment
8 image detection device
9 user interface
10 user
11 control device
12 computing unit control device
13 storage unit control device
14 communication device control device
15 computing unit extended reality display device
16 storage unit extended reality display device
17 communication device extended reality display device
18 energy storage
20 optoelectronically readable code
21 contour target position of clamping means
22 support device
23 machining tool
24 contour target position workpiece
25 virtual operating element
i to xvi parts in the method
k1 target machining contour

1. An arrangement comprising:
at least one CNC machining center for machining, in particular by chip removal, at least one workpiece, in particular a plate-shaped workpiece, in particular made of wood or of at least one wood substitute material,
at least one user-wearable display device,
wherein the at least one user-wearable display device is designed as an extended reality display device, wherein the arrangement further comprises
at least one image detection device, which detects image data of a real environment of the at least one CNC machining center in real time, and
at least one computing unit configured to create extended reality content,
wherein the at least one computing unit configured to create extended reality content creates virtual content related to the at least one CNC machining center and converts it into an extended reality-compatible format,
wherein the at least one computing unit configured to create extended reality content processes the image data detected by the at least one image detection device and converts it into an extended reality-compatible format,
wherein the extended reality display device displays both the virtual content related to the at least one CNC machining center and the processed image data of the real environment of the at least one CNC machining center.

2. The arrangement according to claim 1, wherein the at least one image detection device can detect image data relating to movements performed by a user, wherein the at least one computing unit configured to create extended reality content is configured to recognize in the image data user movements as operating commands for creating extended reality content and/or as control commands for controlling machine functions of the at least one CNC machining center.

3. The arrangement according to claim 1, wherein the virtual content relating to the CNC machining center comprises:
at least one virtual user interface with at least one virtual operating element for controlling machine functions of the at least one CNC machining center, and/or
a virtual representation of operating parameters of the at least one CNC machining center, and/or
a virtual representation of assistance features for operating the at least one CNC machining center.

4. The arrangement according to claim 1, wherein the at least one image detection device can detect image data of optoelectronically readable codes, in particular QR codes, wherein the at least one computing unit configured for creating extended reality content is configured to decode the encoded data contained in the image data, wherein the at least one computing unit configured for creating extended reality content creates virtual content related to the decoded data and converts it into an extended reality-compatible format for display by the extended reality display device.

5. The arrangement according to claim 1, wherein the at least one image detection device can detect image data of an arrangement and configuration of functionally interconnected assemblies of the at least one CNC machining center, wherein the at least one computing unit configured to create extended reality content is configured to detect deviations from a target arrangement and/or a target configuration of the functionally interconnected assemblies, wherein the at least one computing unit configured to create extended reality content creates virtual reality content related to the target arrangement and/or the target configuration of the functionally interconnected assemblies and converts it into an extended reality-compatible format for display by the extended reality display device.

6. The arrangement according to claim 1, wherein the at least one image detection device can detect image data of a storage device for machining tools of the at least one CNC machining center, wherein the at least one computing unit configured to create extended reality content is configured to detect deviations from a target loading of the storage device with machining tools, wherein the at least one computing unit configured to create extended reality content creates virtual reality content related to the target loading of the storage device with machining tools and converts it into an extended reality-compatible format for display by the extended reality display device.

7. The arrangement according to claim 1, wherein data relating to the machining processes to be performed by the at least one CNC machining center can be supplied to the at least one computing unit configured to create extended reality content, wherein the at least one computing unit configured to create extended reality content creates virtual content related to the machining processes to be performed and converts it into an extended reality-compatible format for display by the extended reality display device.

8. A method for displaying extended reality content relating to at least one CNC machining center by means of an extended reality display device, wherein:
at least one image detection device detects image data of a real environment of the at least one CNC machining center in real time,
at least one computing unit configured to create extended reality content processes the image data detected by the at least one image detection device and converts it into an extended reality-compatible format,
at least one computing unit configured to create extended reality content creates virtual content related to the at least one CNC machining center and converts it into an extended reality-compatible format, and
the extended reality display device displays both the virtual content related to the at least one CNC machining center and the processed image data of the real environment of the at least one CNC machining center.

9. The method according to claim 8, wherein the extended reality display device displays virtual content related to the at least one CNC machining center in the form:
of at least one virtual user interface with at least one virtual operating element for controlling machine functions of the at least one CNC machining center, and/or
of a virtual representation of operating parameters of the at least one CNC machining center, and/or
of a virtual representation of assistance features for operating the at least one CNC machining center.

10. The method according to claim 1, wherein:
the at least one image detection device detects image data relating to movements performed by a user, and
the at least one computing unit configured to create extended reality content recognizes detected user movements as operating commands for creating extended reality content and/or as control commands for controlling machine functions of the at least one CNC machining center in the image data.

11. The method according to claim 8, wherein:
the at least one image detection device detects image data of optoelectronically readable codes, in particular QR codes,
the at least one computing unit configured to create extended reality content decodes the encoded data contained in the image data, and
the at least one computing unit configured to create extended reality content creates virtual content related to the decoded data and converts it into an extended reality-compatible format for display by the extended reality display device.

12. The method according to claim 8, wherein:
the at least one image detection device detects image data of an arrangement and configuration of functionally interconnected assemblies of the at least one CNC machining center,
the at least one computing unit configured to create extended reality content detects deviations from a target arrangement and/or a target configuration of the functionally interconnected assemblies, and
the at least one computing unit configured to create extended reality content creates virtual content related to the target arrangement and/or target configuration of the functionally interconnected assemblies, and converts it into an extended reality-compatible format for display by the extended reality display device.

13. The method according to claim 8, wherein:
the at least one image detection device detects image data of a storage device for machining tools of the at least one CNC machining center,
the at least one computing unit configured to create extended reality content detects deviations from a target loading of the storage device with machining tools, and
the at least one computing unit configured to create extended reality content creates virtual content related to the target loading of the storage device with machining tools and converts it into an extended reality-compatible format for display by the extended reality display device.

14. The method according to claim 8, wherein:
data relating to machining processes to be performed of the at least one CNC machining center are supplied to the at least one computing unit configured for creating extended reality content, and
the at least one computing unit configured to create extended reality content creates virtual content related to the machining processes to be performed and converts it into an extended reality-compatible format for display by the extended reality display device.

15. A use of an extended reality display device wearable on the body of a user for carrying out a method according to claim 8.
